(19) United States
(12) Patent Application Publication
(10) Pub. No.: US 2006/0254730 A1
(43) Pub. Date: Nov. 16, 2006

(54) Frameless garage door panel section and garage door assembly incorporating same

(76) Inventor: Albert Wood, Brampton (CA)

Correspondence Address: RICHES, MCKENZIE & HERBERT, LLP, SUITE 1800, 2 BLOOR STREET EAST, TORONTO, ON, M4W 3J5, CA

(21) Appl. No.: 11/345,239

(22) Filed: Feb. 2, 2006

(30) Foreign Application Priority Data
May 13, 2005 (CA) 2,507,205

(51) Int. Cl. E06B 3/12

(52) U.S. Cl. 160/236

(57) ABSTRACT

A light-weight garage door panel section for use in an articulated garage door assembly includes a rectangular face panel, a pair of elongated extruded upper and lower channel members which function as horizontal rail supports, and two or more stiles. The channel members are each formed so as to define a longitudinally extending retaining channel therein. The channels are preferably each delineated laterally by a pair of generally parallel spaced front and rear webs. The upper surface of the upper channel member includes a longitudinally extending, upwardly curving convex portion. The lower surface of the lower channel member is formed having a longitudinally extending, upwardly curving concave portion having substantially the same radius of curvature as the convex portion, such that the upper surface of one garage door section is adapted for mating engagement with the lower surface of a next immediately adjacent panel section positioned thereabove. In assembly, the retaining channels are provided in an opposed downwardly and upwardly open orientation, and the face panel is partially located therein to couple the face panel thereto, with the upper and lower channel members forming the upper and lower edges of each panel section.

### SCOPE OF THE INVENTION

The present invention relates to a frameless garage door panel section for use in a garage door construction and more particularly, a light-weight panel section which includes a pair of elongated upper and lower extruded channel members used to mount one or more planar face panels thereto.

### BACKGROUND OF THE INVENTION

Articulated overhead-type garage door assemblies are well known. Typically, conventional garage door assemblies include an articulated door which consists of four or five elongate rectangular panel sections which are hingely connected to each other along their upper and lower edges. A series of guide rollers secured to each lateral edge of the panel sections are used to permit movement of the panel sections along guide tracks, first riding upwardly and then horizontally, as the garage door is opened.

The door panel sections used in conventionally articulated door assemblies are most frequently manufactured by securing a plywood face panel as a floating recessed panel within a mortised, rectangular hardwood frame. Typically, the hardwood frames are formed by coupling a pair of 2.5 metre boards which function as horizontal rails for the frame, to either two or three 0.3 to 0.6 metre long wooden vertical brace supports or stiles. Stiles are secured at each end of the horizontal rails, and depending upon the overall rail length, optionally at a mid-portion as a center support. Conventional garage door panel sections suffer a disadvantage, however, in that the material costs associated with providing 2.5 metre long hardwood boards as horizontal rail supports, increases manufacturing costs. The use of a four-sided rectangular hardwood frame in panel section construction furthermore adds to the overall weight of each section, increasing the load forces on the guide tracks and reducing the overall life span of the garage door assembly. In addition, in humid or snowy winter environments, the hardwood rails may be susceptible to rot, shortening the overall door life span.

In an effort to overcome at least some of the disadvantages associated with conventional hardwood framed door panel sections, U.S. Pat. No. Des. 273,230 to Martinez illustrates an articulated garage door assembly in which the individual garage door panel sections are formed with rail supports made from a bent or rolled sheet of steel. In the Figures, Martinez shows the rolled steel rail supports as being bent so as to provide a front channel used to physically engage the upper and lower edge portions of a face panel, to secure it in place. The rail supports are further shown with a horizontal top/bottom flange provided with a rolled back lip for maintaining a desired spacing immediately adjacent rails when the door assembly is closed. Holes pre-drilled through the top/bottom flange permit attachment of the rails to the top or bottom ends of the vertical stiles by means of wood screws.

The door construction of Martinez, however, suffers the disadvantage in that the face panel is adapted to be retained solely by its engagement with the front channel of the bent rail. As such, the front panels may be susceptible to lateral shifting and/or movement relative to the rails as the garage door is opened or closed. In addition, the insertion of connecting screws into the ends of the stiles permits only the comparatively weak physical attachment of the rails into the end grain of wooden stile members. This weaker attachment may result in the screws loosening or even pulling out from the end grain, and door failure.

### SUMMARY OF THE INVENTION

Accordingly, it is an object of the present invention to provide a garage door assembly which incorporates lighter garage door panel sections to achieve a finished articulated garage door with an overall reduced weight, increasing the door assembly life span.

Another object of the invention is to provide a garage door assembly which includes a number of frameless door panel sections in which one or more planar face panels are each mechanically secured to extruded, cast or molded channel supports, to substantially prevent any lateral sliding movement of the face panels relative to the channel supports.

Another object of the invention is to provide an articulated garage door panel section which includes a pair of extruded aluminum horizontal rail supports which have one or more attachment webs positioned for juxtaposed attachment to a side surface of an elongated wooden vertical stile.

A further object of the invention is to provide an articulated garage door assembly which incorporates a metal, nylon or other plastic extrusions in place of a hardwood horizontal rail frame construction, to minimize door weight and manufacturing costs and reduce susceptibility to weathering.

A further object of the invention is to provide a light-weight garage door panel section which may be easily and quickly assembled for coupling to other door panel sections in the assembly of a garage door, and which is adapted for mounting one or more face panels made from plastics, metals, and/or natural or engineered woods, to permit the finished garage door assembly to be easily customized having regard to specific client tastes.

To at least partially achieve some of the aforementioned objects, the present invention provides for a light-weight garage door panel section for use in an articulated garage door assembly. Each panel section includes at least one generally rectangular face panel, a pair of elongated extruded, cast or molded upper and lower channel members which function as horizontal rail supports, and at least two brace members or stiles. The channel members are provided in place of conventional hardwood horizontal rails. Each of the upper and lower channel members is formed so as to define a longitudinally extending retaining channel therein, which in assembly, are respectively provided in an opposed downwardly and upwardly open orientation. In assembly, at least part of the face panels are partially located in each retaining channel to assist in maintaining the face panel coupled thereto, with the upper and lower channel members forming the upper and lower elongate horizontal edges of each panel section.

The upwardly and downwardly open channels are preferably each delineated laterally by a pair of generally parallel spaced front and rear webs. Although not essential, the upper and lower channel members are preferably provided with respective lower and upper surfaces which are formed for substantially mating engagement with each other. In this configuration, the upper horizontal edge surface of one garage door section is adapted for mating engagement with the lower horizontal edge surface of the next immediately adjacent panel section positioned thereabove. In a most preferred configuration, the upper surface of the upper channel member includes a longitudinally extending, upwardly curving convex portion. The lower surface of the lower channel member is formed having a longitudinally extending, upwardly curving concave portion having substantially the same radius of curvature as the convex portion. The mating engagement of the convex portion with the concave portion of an adjacent panel advantageously provides a labyrinth-type seal, minimizing the possibility that rain or snow may pass therebetween.

In a most simplified construction, hardwood stiles 0.3 to 0.8 metres in length are provided in a vertical arrangement, and secured to the rear web of each of the upper and lower panel members by screws or other mechanical fasteners. The stiles or brace members may, however, be secured in other configurations and/or consist of other materials or constructions, including softwood, engineered woods, or metal or plastic constructs or extrusions for coupling to the channel members. In final assembly, the face panel is secured between the pair of elongated upper and lower channel members, with the stiles provided to maintain structural integrity for the panel section and the desired positioning of the upper and lower channel members with the door face panel secured therebetween, without the need for a conventional panel frame having hardwood rails.

For ease of manufacture, the channel members are most preferably each formed as a single solid aluminium extrusion. It is to be appreciated, however, that the channel members could also be formed of other materials and/or as other extrusions, moldings or castings, made from plastics, carbon fibres, metals or the like.

The face panel is typically provided as a generally planar rectangular panel which includes upper and lower edge portions which are sized to locate in the retaining channels of the channel members. The face panels may be formed from a variety of materials including conventional plywood, natural woods, plastics, vinyls or even metals. Most preferably, however, for increased weather resistance, the face panels are manufactured from a plastic or resin impregnated engineered wood composite. For increased aesthetics, the face panels may furthermore include a raised, embossed or floating panel design, glass lights, or other architectural features.

Accordingly, in one aspect the present invention resides in a garage door panel section comprising,

a pair of elongate upper and lower channel members, and a generally rectangular face panel coupled between said channel members,

the upper channel member comprising,
an upper surface having a longitudinally extending upwardly convex forward portion, and
a lower surface having a longitudinally extending downwardly open retaining channel, the downwardly open retaining channel delineated laterally by forward and rearward webs and sized to receive a first edge portion of said face panel at least partially therein,

the lower channel member comprising,
an upper surface including a longitudinally extending upwardly open retaining channel, the upwardly open retaining channel delineated laterally by forward and rearward webs and sized to receive a second edge portion of said face panel at least partially therein, and
a lower surface having a longitudinally extending upwardly concave forward portion, the upwardly concave forward portion sized for mated juxtaposition with the upwardly convex forward portion of the upper channel member of a next adjacent door panel when vertically aligned therewith,

a plurality of brace members for maintaining said upper and lower channel members in a generally parallel spaced orientation, with said first edge portion of said face panel at least partially disposed in said downwardly open channel and said second edge portion of said face panel at least partially disposed in said upwardly open channel.

In another aspect, the present invention resides in a garage door assembly including an articulated garage door comprising a plurality of hingely connected door panel sections adapted to assume a generally co-planer orientation when said door is moved to a closed position, each of said door panel sections including,

an extruded aluminum upper channel member, an extruded aluminum low rectangular panel member, and a generally rectangular panel member,

the upper channel member including,
an upper surface defining a longitudinally elongated upwardly convex forward portion, and
a lower surface including a longitudinally extending downwardly open channel delineated laterally by forward and rearward webs, the downwardly open channel receiving a top edge portion of said panel member at least partially therein,

the lower channel member including,
an upper surface including a longitudinally extending upwardly open channel delineated laterally by forward and rearward webs, the upwardly open channel receiving a bottom edge portion of said panel member at least partially therein, and
a lower surface including an upwardly concave forward portion having a radius curvature generally corresponding to a radius of curvature of the upwardly convex portion,

brace members for maintaining said upper and lower channel members in a generally parallel spaced orientation, with said top edge portion of the panel member in said downwardly open channel and said bottom edge portion of the panel member in said upwardly open channel,

a hinge assembly hingely connecting the brace members of a first lower one of said door panel sections to a next adjacent upper one of said door panel sections, and wherein when said door assembly is moved to said closed position the upwardly concave forward portion of the lower channel member of the upper door panel section assuming a position in substantially juxtaposed mating contact with the upwardly convex forward position of the upper channel member of the lower door panel section.

In a further aspect, the present invention resides in a garage door panel section comprising,

a pair of elongate upper and lower channel members, and a generally rectangular face panel, the face panel having substantially parallel upper and lower edges,

the upper channel member comprising a metal extrusion and including,
an upper surface having a longitudinally extending upwardly convex forward portion, and
a lower surface having a longitudinally extending downwardly open retaining channel, the downwardly open retaining channel delineated laterally by forward and rearward webs and sized to receive the upper edge portion of said panel member at least partially therein,

the lower channel member comprising a metal extrusion and including,
an upper surface including a longitudinally extending upwardly open retaining channel, the upwardly open retaining channel delineated laterally by forward and rearward webs and sized to receive the lower edge of the face panel at least partially therein, and
a lower surface having a longitudinally extending upwardly concave forward portion, the upwardly concave forward portion sized for mated juxtaposition with the upwardly convex forward portion of the upper channel member of a next adjacent door panel when vertically aligned therewith,

a plurality of elongated stile members for maintaining said upper and lower channel members in a generally parallel spaced orientation, with the upper edge of the face panel at least partially disposed in said downwardly open channel and the lower edge of the face panel at least partially disposed in said upwardly open channel.

### BRIEF DESCRIPTION OF THE DRAWINGS

Reference may now be had to the following detailed description taken together with the accompanying drawings in which:

FIG. 1 illustrates a schematic front view of an articulated garage door assembly in accordance with the preferred embodiment of the invention;

FIG. 2 illustrates a schematic rear view of the garage door assembly of FIG. 1 with the door in a fully closed position;

FIG. 3 illustrates a section view of the garage door used in the assembly of FIG. 1 taken along lines 3-3′, moved to an initial partially open position;

FIG. 4 shows an enlarged cross-sectional view of a garage door panel section used in the garage door assembly of FIG. 1;

FIG. 5 illustrates a cross-sectional view of a garage door panel section in accordance with a further embodiment of the invention;

FIG. 6 shows a cross-sectional view of two lowermost vertically adjacent garage door panel sections for use in an articulated garage door in accordance with a further embodiment of the invention; and

FIG. 7 shows a cross-sectional view of a garage door panel section in accordance with a further embodiment of the invention.

### DETAILED DESCRIPTION OF THE PREFERRED EMBODIMENTS

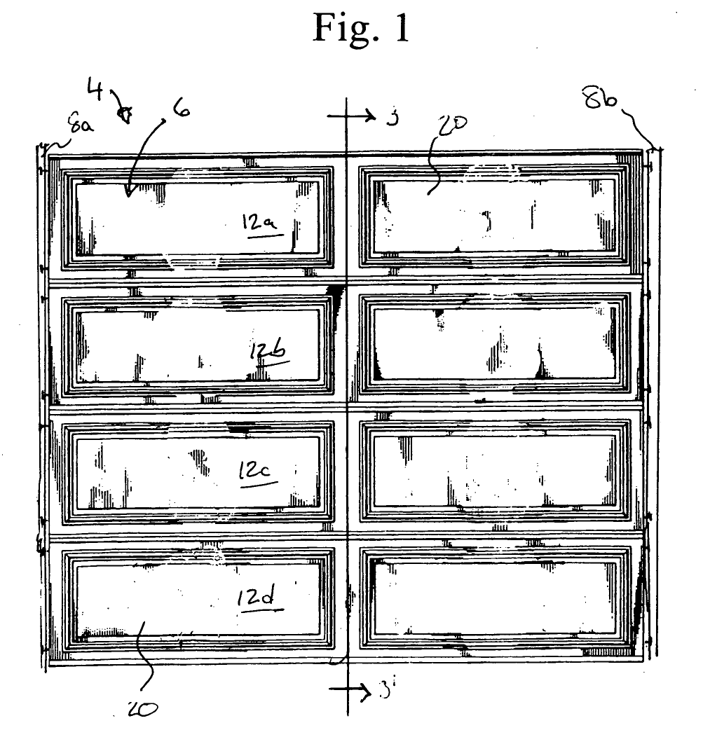

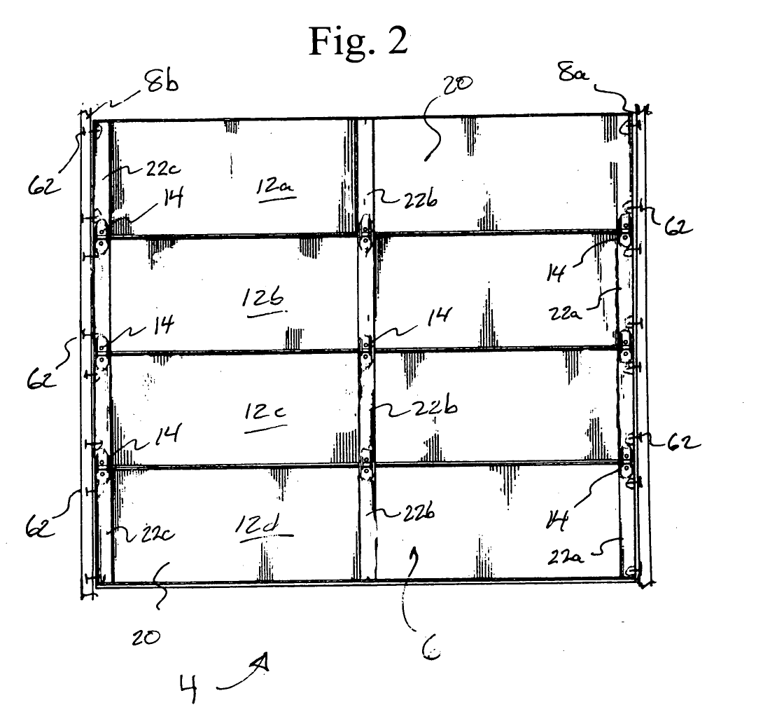

Reference is first made to FIGS. 1 and 2 which illustrate an articulated garage door assembly 4 in accordance with a preferred embodiment of the invention, and which includes an articulated garage door 6 which is movable along a pair of conventional guide tracks 8a,8b. The garage door 6 is shown in FIGS. 1 and 2 in a fully closed configuration, and includes four hingely coupled garage door panel sections 12a,12b,12c,12d. Each of the door panel sections 12a,12b,12c,12d are hingely coupled to the immediately adjacent panel sections 12 along their abutting elongated horizontal edges by a series of hinges 14 (FIG. 2). The garage door 6 is adapted for sliding movement in a conventional manner along the pair of guide tracks 8a,8b from the closed position shown in FIGS. 1 and 2, in which the panel sections 12a,12b,12c,12d are arranged in the generally co-planar vertical arrangement, shown to a raised open position in which each of the panel sections 12a, 12b, 12c, 12d assumes a generally horizontal co-planar orientation.

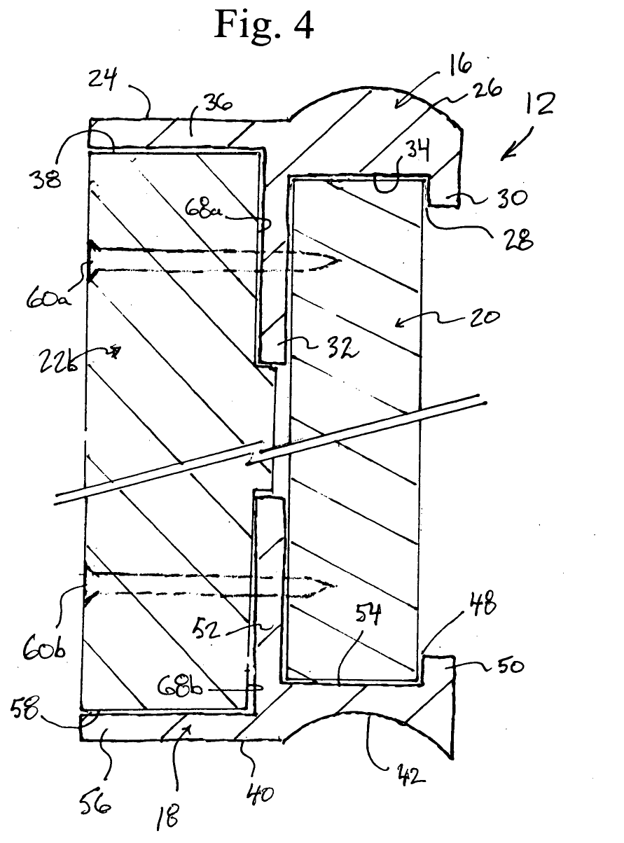

Although not essential, in a simplified embodiment, each of the door panel sections 12,12b, 12c, 12d has the identical construction of the panel 12 shown in enhanced cross-sectional view in FIG. 4. The panel sections 12 each include a pair of elongated horizontally extending upper and lower channel members 16,18, a generally rectangular face panel 20 and three elongated hardwood brace members or stiles 22a,22b,22c (shown in FIG. 2) which extend normal to the channel members 16,18 and vertically when the door 6 is closed.

The upper and lower channel members 16,18 are each formed as solid aluminum extrusions and extend the longitudinal length of the panel section 12, typically having a length of between about 1.5 and 2.5 metres depending on the desired width of the door 6 and the spacing of the guide tracks 8a,8b. In assembly, the channel members 16,18 are provided in place of horizontal hardwood rails, as for example, would be used in the frame of a conventional garage door. In this regard, the upper and lower channel members 16,18 effectively define the respective upper and lower horizontal edges of each panel section 12.

The enlarged cross-sectional view of the panel section 12 shown in FIG. 4 shows best the upper channel member 16 as formed having an uppermost surface 24 which includes an upwardly convex forward portion 26. The convex forward portion 26 extends longitudinally along the length of the panel section 12 and has a lateral width which is preferably selected at between about 1 and 2 cm, and a radius of curvature of between about 0.5 and 5 cm. The channel member 16 further defines a downwardly open retaining channel 28 which extends the longitudinal length of the channel member 16 beneath the convex portion 26. The retaining channel 28 is delineated laterally by a pair of spaced front and rear webs 30,32 which are separated from each other by a generally planar central bight 34. Preferably, the webs 30,32 are spaced from each other so as to provide the channel 28 with a generally square cross-sectional profile and a lateral width of about 1 and 1½ cm, other cross-sectional profiles and dimensions for the retaining channel 28 are, however, possible. As shown best in FIG. 4, the front web 30 extends perpendicularly downwardly from the channel bight 34 a distance of about 1 and 5 mm. As will be described, the rear web 32 extends perpendicularly downwardly from the bight 34 a preferred distance of between about 1 and 2 cm so as to provide an upper engagement surface for wood screws 60a used in the assembly of the panel section 12. Although not essential, a generally horizontally extending locating flange 36 is preferably also provided. The locating flange 36 extends the longitudinal length of the channel member 16 and projects perpendicularly rearward from the rear web 32, immediately adjacent to the convex forward portion 26. The locating flange 36,is oriented for abutting contact with an upper edge 38 of each stile 22 to facilitate the desired positioning of the channel member 16 relative to the stiles 22 in assembly of the garage door panel section 12.

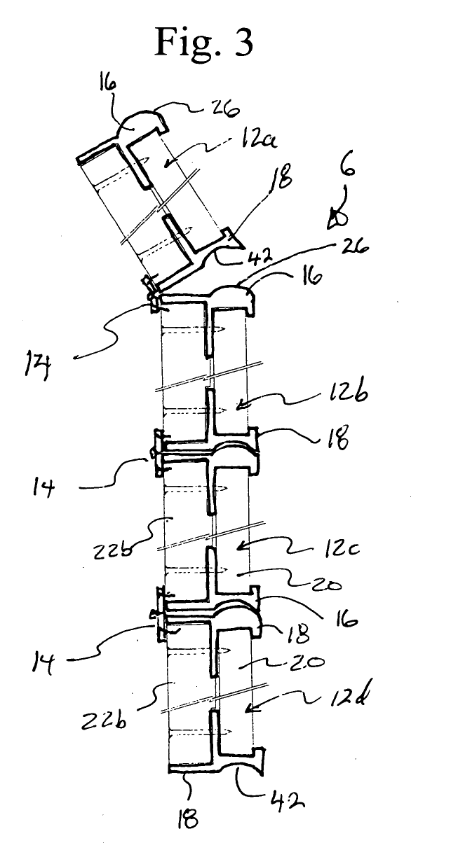

The lower channel member 18 is similarly formed as a solid aluminum extrusion which is cut to the longitudinal length of the individual panel section 12. The lower channel member 18 includes a lower surface 40 which defines a longitudinally extending upwardly concave forward portion 42. As shown best in FIG. 3, the concave forward portion 42 of the lower channel member 18 has a lateral width and profile which is selected for mating engagement with the convex forward portion 26 of the upper channel member 16. In this configuration as shown best in FIG. 3, lower surface 40 of the channel member 18 of one panel section 18 is adapted for mating contact with the upper surface 26 of the next lower vertically adjacent panel section 12, so as to permit nested engagement therebetween. The lower channel member 18 further defines an upwardly open retaining channel 48. Although not essential, the upwardly open retaining channel 48 preferably has substantially the mirror profile to the downwardly open retaining channel 28 of the upper channel member 16. The retaining channel 48 is delineated laterally by front and rear webs 50,52 which extend generally perpendicularly upward from a generally planar or flat bight 54. The front web 50 extends upwardly from the bight 54 a distance of between about 1 and 5 millimetres, with the rear web 52 extending therefrom approximately 1 to 2 cm so as to provide a lower engagement surface for screws 60b in the assembly of the panel section 12. The lower channel member 18 preferably also includes a generally horizontally extending locating flange 56. The locating flange 56 extends the longitudinal length of the channel member 18 and projects rearwardly from the lower edge of the rear web 52 adjacent the concave lower portion 42. As with the locating flange 36, the locating flange 56 is provided for abutting contact with the stiles 22 along their lower edges 58 to facilitate the desired positioning of the channel member 18 relative to the stiles 22 in panel section assembly. Although not essential, preferably, each of the locating flanges 36,56 have a lateral extent which is selected less than or equal to the thickness of the stiles 22.

It is to be appreciated that by forming the upper surface 24 of each panel section 12 with a convex forward portion 26, the engagement of the convex upper portion 26 with the concave recess 42 of the lower channel member 18 of the next vertically adjacent panel section provides a labyrinth-like seal, preventing water or snow from moving between adjacent panel sections 12a,12b,12c,12d when garage door 6 is closed. Furthermore, the convex upper surface 24 of each channel member advantageously tends to deflect outwardly any moisture which otherwise may come between adjacent door panel sections 12a,12b,12c,12d, further minimizing moisture damage to the door 6.

FIGS. 1 and 4 show best the face panel 20 used in the assembly of the garage door panel sections 12a,12b,12c,12d. Face panel 20 may be formed from a variety of materials including natural wood, but most preferably consists of a rectangular engineered wood/resin composite panel. The panel 20 has a length selected at between about 2.25 and 5.5 metres, a vertical height of about 0.3 to 0.8 metres, and preferably 0.4 to 0.6 metres, and a lateral thickness of between about 0.5 and 2.5 cm. In a most simplified embodiment, the face panel 20 has a lateral thickness which is marginally less than the width of the channel member bights 34,54. The longitudinal length of the face panel 20 preferably corresponds to the lateral width of the finished garage door 6, with the height selected having regard to the number of panel sections 12 to be included and the desired finished door height.

FIGS. 2 and 3 show best each panel section 12a, 12b, 12c, 12d as including three vertical stiles 22a,22b,22c. In a simplified construction, the stiles 22a,22b,22c have the identical length and width, with each stile 22 consisting of a rectangular length of 1 to 2 cm thick hardwood. The length of the stiles 22a,22b,22c is preferably selected to ensure proper nesting of the face panel 20 in position with its upper and lower horizontal edges in juxtaposed contact with the bights 34,54, respectively. FIG. 4 shows best the screws 60a,60b as being driven through the back of each stile (22b shown) so as to engage the cross-grain of the stile 22 and pass through respectively, the rear webs 32,52 of each of the upper and lower channel members 16,18. Although not essential, most preferably the screws 60a,60b have a length chosen to extend through the respective webs 32,52 and partway into the front panel 20, to further secure the panel 20 against lateral movement relative to the channel members 16,18.

As shown best in FIG. 2, the hardwood stiles 22a,22b,22c advantageously further act as a mounting surface for the hinges 14 used to articulated connection of adjacent door panel sections 12a,12b,12c,12d to each other. In this regard, FIG. 3 shows the garage door assembly 4 in an initially partially opened orientation in which the uppermost garage door panel section 12a begins to move in an articulated fashion along the guide tracks 8a,8b (FIG. 2). As each panel section 12a moves from a vertical orientation to a generally horizontal orientation as the panel sections 12a,12b,12c,12d raised, the sections 12a,12b,12c,12d pivot about the hinges 14. In addition, the stiles 22a,22c located along each vertical edge of the door 6 also act as mounting surfaces for the door assembly rollers 62 (FIG. 2) which are used to slidably mount the door 6 to the guide tracks 8a,8b.

It is to be appreciated that the abutting contact of the locating flanges 36,56 with the upper and lower ends 38,58 of each stile 22 assists in ensuring the proper spacing positioning of the channel members 16,18 in the assembly of the individual door panel sections 12. Although not essential, optionally each of the stiles may further include upper and lower rabbeted recesses 68a,68b (FIG. 4) along the respective upper and lower edges 38,58. The rabbeted recesses 68a,68b are shown having a dimension which is complementary to the length and dimensional width of the rear webs 32,52, respectively so as to ensure proper positioning of the webs 32,52 therein.

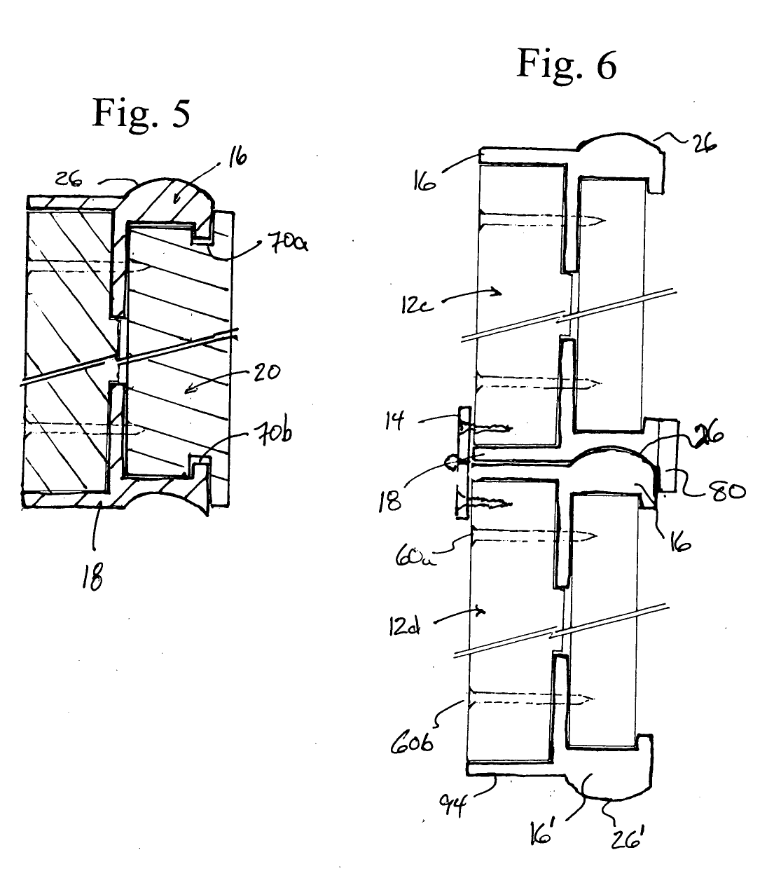

Although the garage door assembly 4 shown in FIGS. 1 to 4 illustrates door panel sections 12 in which the face panel 20 is retained completely within the downwardly and upwardly open channels 28,48 of the upper and lower channel members 16,18, the invention is not so limited. Reference may be had to FIG. 5 which illustrates a further embodiment of the invention in which like reference numerals may be used to identify like components. In FIG. 5, the face panel 20 is provided with a lateral width which is selected greater than the lateral width of the channels 28,48. The inward facing edge portion of the panel 20 is rabbeted to include longitudinally extending upper and lower recesses 70a,70b. The recesses 70a,70b have a width and depth selected to enable the positioning of the front webs 30,50 of the upper and lower channel members 16,18 at least partially therein, to physically couple the face panel 20 to the channel members 16,18. It is to be appreciated that the thicker face panel 20 provided in the door panel section 12 of FIG. 5 may advantageously provide greater flexibility in ornamental designs to be applied to the finalized door assembly 4. In particular, thicker face panels 20 may be used to provide the door with a more pronounced raised panel look. In addition, the location of the front webs 30,50 within the recesses 70a70b may be used to more fully conceal the upper and lower channel members 16,18 in the finished garage door assembly 10, to provide an alternate possible door lock.

Reference may be had to FIG. 6 which illustrates two lowermost garage door panel sections 12c, 12d used in a garage door assembly 4 in accordance with a further embodiment of the invention, wherein like reference numerals are used to identify like components. In FIG. 6, the lower channel member 18 of the garage door panel 12c is provided with a finger guard 80. The finger guard 80 extends longitudinally the length of the channel member 18 so as to project downwardly a distance of about 0.3 to 1 cm across the front of the upper channel member 16 of the lower adjacent panel section 12d when the door 6 is fully closed, and the door panel sections 12c, 12d are vertically aligned. It is to be appreciated that the downward extent of the finger guard 80 minimizes the likelihood that fingers could be pinched between individual door panel sections 12a, 12b, 12c, 12d as they travel in articulated movement about their respective hinges 14 as the door 6 is opened or closed.

FIG. 6 furthermore shows the lowermost door panel section 12d as including a lower channel member 16′ having the identical inverted profile as the upper channel member 16. With the construction shown, when the door 6 is closed, the lower channel member 16′ presents a downwardly convex forward portion 26′ for engagement with the floor. It is to be appreciated that although the lower channel member 16′ is illustrated with a lower surface 94 which is identical to the uppermost surface 24 of the upper channel member 16, the invention is not so limited. In an alternate construction, the bottom channel member 16′ could include an extruded recess which is adapted to receive a rubber or synthetic weather seal strip therein.

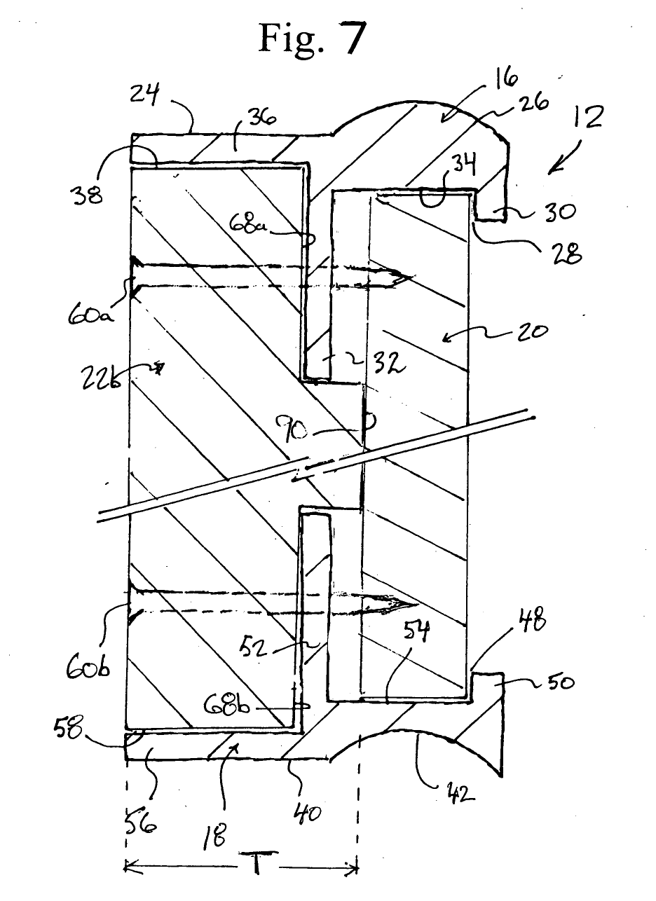

FIG. 7 shows a further embodiment of the invention wherein the reference numerals are used to identify like components. In FIG. 7, the vertical stiles 22 are provided with an increased dimensional thickness T selected at between about 2 and 4 cm, and preferably about 3 and 5 cm. The rabbeted recesses 68a,68b are cut to an increased depth in the stiles 22 selected such that when secured to the channel members 16,18, a face surface 90 of each stile 22 projects forwardly past the rear webs 32,52 and rearwardly from the front webs 30,50. The applicant has appreciated that such thicker stiles 22 advantageously may be used to maintain the correct positioning of comparably thinner face panels 20 in substantial abutting contact with the front webs 30,50, where panels 20 having a lateral thickness less than the lateral width of the channels 28,48 are used. For example, to achieve a more economical construction, the door panel section 12 of the FIG. 7 advantageously permits the use of face panels 20 having a lateral thickness selected less than about 1 cm.

Although preferred embodiments of the invention describes the channel members 16,18 as being formed as aluminum extrusions, the invention is not so limited. It is to be appreciated that the upper and lower channel members 16,18 could also be formed from other metals or as either plastic or carbon fibre extrusions, or as molded or cast profiles.

Although the use of hardwood stiles or brace members 22a,22b,22c provides a simplified and economical garage door assembly construction, the invention is not so limited. If desired, brace members formed from engineered woods, or metal or plastics could also be used without departing from the spirit and scope of the invention.

Although the detailed description describes and illustrates various preferred embodiments, the invention is not so limited. Many modifications and variations will now occur to persons skilled in the art. For a definition of the invention reference may be had to the appended claims.

I claim:

1. A garage door panel section comprising,
a pair of elongate upper and lower channel members, and a generally rectangular face panel coupled between said channel members,
the upper channel member comprising,
an upper surface having a longitudinally extending upwardly convex forward portion, and
a lower surface having a longitudinally extending downwardly open retaining channel, the downwardly open retaining channel delineated laterally by forward and rearward webs and sized to receive a first edge portion of said face panel at least partially therein,
the lower channel member comprising,
an upper surface including a longitudinally extending upwardly open retaining channel, the upwardly open retaining channel delineated laterally by forward and rearward webs and sized to receive a second edge portion of said face panel at least partially therein, and
a lower surface having a longitudinally extending upwardly concave forward portion, the upwardly concave forward portion sized for substantially mated juxtaposition with the upwardly convex forward portion of the upper channel member of a next adjacent door panel when vertically aligned therewith,
a plurality of brace members for maintaining said upper and lower channel members in a generally parallel spaced orientation, with said first edge portion of said face panel at least partially disposed in said downwardly open channel and said second edge portion of said face panel at least partially disposed in said upwardly open channel.

2. The garage door panel section as claimed in claim 1 further including mechanical fasteners for mechanically coupling each said brace member to both of the rearward webs of the upper and lower channel members and said panel member.

3. The garage door panel section as claimed in claim 2 wherein each of said brace members comprises a length of wood stock having generally parallel upper and lower ends, said ends further including a rabbeted recess portion sized to respectively receive the rearward web of the upper and lower channel members substantially therein.

4. The garage door panel section as claimed in claim 1 wherein the upper channel member includes an upper locating flange extending generally rearwardly from said convex forward portion, and said lower channel member includes a lower locating flange extending generally rearwardly from said concave forward portion,
the upper and lower locating flanges having a configuration selected so that when the concave forward portion of the lower channel member is substantially moved into mated juxtaposition with the convex forward portion of the adjacent garage door panel, the lower locating flange of the upper adjacent panel section is positioned in substantially juxtaposed contact with the upper locating flange of the lower door panel section.

5. The garage door panel section as claimed in claim 2 wherein the rearward webs delineating each of the upwardly and downwardly open retaining channels extend a distance of at least about 1.2 cm, and
said mechanical fasteners comprise screws.

6. The garage door panel section as claimed in claim 1 wherein the upper and lower channel members have a length selected to extend substantially equal to a longitudinal length of the face panel, and
the brace members include a pair of wooden end stiles disposed adjacent to a respective face panel end.

7. The garage door panel section as claimed in claim 1 wherein the downwardly open, retaining channel has a width selected marginally greater than the first edge portion of the face panel to enable its positioning entirely therein, and the forward web of upper channel member extends from a central channel bight a distance selected less than about 0.5 cm.

8. The garage door panel section as claimed in claim 6, wherein each of said brace blocks comprises hardwood stock having a thickness of between about 1 and 3 cm and a length selected at between about 20 and 100 cm.

9. The garage door panel section as claimed in claim 5 wherein said upper and lower channel members each comprise an aluminum extrusion.

10. The garage door panel section as claimed in claim 1 wherein each of said upwardly and downwardly open retaining channels have a generally square cross-sectional profile with a lateral width selected at between about 1 and 1.5 cm.

11. The garage door panel section as claimed in claim 10 wherein each door panel section further includes mechanical fasteners for mechanically coupling said brace members to the rearward webs of both of the upper and lower channel members.

12. A garage door assembly including an articulated garage door comprising a plurality of hingely connected door panel sections, said door panel sections being selectively movable to a generally co-planer orientation when said door is moved to a closed position, each of said door panel sections including,
an extruded aluminum upper channel member, an extruded aluminum lower channel member and a generally rectangular panel member,
the upper channel member including,
an upper surface defining a longitudinally elongated upwardly convex forward portion, and
a lower surface defining a longitudinally extending downwardly open channel, the downwardly open channel being delineated laterally by forward and rearward webs, and sized to receive a top edge portion of said panel member at least partially therein,
the lower channel member including,
an upper surface defining a longitudinally extending upwardly open channel, the upwardly open channel being delineated laterally by forward and rearward webs and sized to receive a bottom edge portion of said panel member at least partially therein, and
a lower surface defining an upwardly concave forward portion having a radius curvature generally corresponding to a radius of curvature of the upwardly convex portion,
brace members for maintaining said upper and lower channel members in a generally parallel spaced orientation, with said top edge portion of the panel member in said downwardly open channel and said bottom edge portion of the panel member in said upwardly open channel,
a hinge assembly hingely connecting the brace members of a first lower one of said door panel sections to a next adjacent upper one of said door panel sections wherein when said door is moved to said closed position the upwardly concave forward portion of the upper door panel section assuming a position in substantially juxtaposed mating contact with the upwardly convex forward position of the lower door panel section.

13. The garage door assembly as claimed in claim 12 wherein each door panel section further includes mechanical fasteners for mechanically coupling each brace member to the rearward webs of both of the upper and lower channel members.

14. The garage door assembly as claimed in claim 12 wherein said brace members comprise a wooden block having rabbeted upper and lower ends, each said rabbeted end being sized to substantially receive therein a respective one of the rearward webs of the upper and lower channel members.

15. The garage door assembly as claimed in claim 12 wherein the upper channel member further includes an upper locating flange extending generally rearwardly from said convex forward portion, said lower channel member further including a lower locating flange extending generally rearwardly from said concave forward portion,
the lower locating flange having a configuration selected whereby when the door is moved to the closed position and the concave portion of the lower channel member of the upper door panel is positioned substantially in mated juxtaposition with the convex portion of the upper channel member of the next lower door panel section, the lower locating flange of the upper door panel section assumes a position in substantially juxtaposed contact with the upper locating flange of the adjacent lower door panel section.

16. The garage door assembly as claimed in claim 12 wherein said panel member comprises a manufactured wood panel having a thickness selected less than about 1.5 cm.

17. The garage door assembly as claimed in claim 12 wherein the brace members comprise wooden brace members having a thickness selected less than about 2 cm and a lateral width selected at between about 10 and 15 cm.

18. The garage door assembly as claimed in claim 16 wherein each of said upwardly and downwardly open channels has a generally square cross-sectional profile with a lateral width selected at between about 1 and 1.5 cm.

19. A garage door panel section comprising,
a pair of elongate upper and lower channel members, and a generally rectangular face panel, the face panel having substantially parallel upper and lower edges,
the upper channel member comprising a metal extrusion and including,
an upper surface having a longitudinally extending upwardly convex forward portion, and
a lower surface having a longitudinally extending downwardly open retaining channel, the downwardly open retaining channel delineated laterally by forward and rearward webs and sized to receive the upper edge portion of said panel member at least partially therein,
the lower channel member comprising a metal extrusion and including,
an upper surface including a longitudinally extending upwardly open retaining channel, the upwardly open retaining channel delineated laterally by forward and rearward webs and sized to receive the lower edge of the face panel at least partially therein, and
a lower surface having a longitudinally extending upwardly concave forward portion, the upwardly concave forward portion sized for substantially mated juxtaposition with the upwardly convex forward portion of the upper channel member of a next adjacent door panel when vertically aligned therewith,
a plurality of elongated stile members for maintaining said upper and lower channel members in a generally parallel spaced orientation with the upper edge of the face panel at least partially disposed in said downwardly open channel and the lower edge of the face panel at least partially disposed in said upwardly open channel.

20. The garage door section as claimed in claim 19 wherein the stile members have a thickness selected at between about 1 to 2.5 cm and comprise hardwood, the door section further including screw fasteners mechanically coupling said stile members to the rearward web of each of said upper and lower channel members and the face panel.
